(19) United States
(12) Patent Application Publication
(10) Pub. No.: US 2019/0340953 A1
(43) Pub. Date: Nov. 7, 2019

(54) METHODS AND COMPUTER SYSTEM FOR TEACHING DAILY POSITIVE THOUGHTS AND BEHAVIOR AND DAILY USE OF MEDITATION

(71) Applicant: Doris Letts, Williamstown, NJ (US)

(72) Inventor: Doris Letts, Williamstown, NJ (US)

(21) Appl. No.: 15/970,770

(22) Filed: May 3, 2018

(51) Int. Cl. G09B 19/22; A63F 13/825; G06F 15/02

(52) U.S. Cl. CPC G09B 19/22; G06F 15/0291; A63F 13/825

(57) ABSTRACT

The disclosed technology is directed to methods and a system for teaching children the value of daily positive thoughts, affirmations, caring and behavior including the use of meditation to self-regulate thoughts, feelings and behavior. The disclosed methods and system comprise a combination of stories, an inanimate object such as a fictitious character doll and interactive electronic communication.

### BACKGROUND OF THE INVENTION

### 1. Field of the Invention

The disclosed technology relates generally to methods and a system for teaching the value of daily positive thoughts, affirmations, caring and behavior to children including the use of meditation to self-regulate thoughts, feelings and behavior. In particular, the disclosed methods and system comprise generally a combination of stories, an inanimate object such as a fictitious character doll and interactive electronic communication.

### 2. Background and Related Art

Behavioral modification is a subject of social science. Many methods exist seeking to promote positive behavior; some methods include systems of rewards as well as punishments. Punishment as a method of stimulating positive behavior has limited success and often has counter-productive results. Lasting behavior modification is most frequently achieved not by rewards alone but in those persons who learn to recognize the feelings and needs of other, interdependent persons and thereby learn to recognize their own feelings and needs and use positive ways to achieve happiness and contentedness.

### SUMMARY OF THE INVENTION

The disclosed and claimed methods and system promote the development and refinement of life skills including being kind, nurturing, loving, accepting, understanding, cooperative, empathetic, grateful, mindful of the needs, desires and feelings of others, as well as self-control, choosing to be happy, developing a positive self-image and emotional strength. These life skills engender happier adolescents and naturally result in more positive behavior in trusted relationships without resorting to use of punishment, only the delay in the granting of a wish. The disclosed methods and system teach a child the cause and effect relationship between behavior and happiness for others and themselves.

The disclosed and claimed methods and systems teach these life skills using a combination of stories, characters and individualized communication which create a fantasy experience in which the child through commitment and achievement learns the life skills which induce improved, positive behavior and happiness. These methods and systems can be achieved using interactive mobile Apps and computer gaming techniques.

The fantasy stories are presented in either hard- or soft-cover book form, scroll or in electronic form such as an App or other computer game. The fantasy stories of the disclosed and claimed methods and system are chosen to put the child in charge and control of the child's own acts which increase the happiness of the fantasy experience. In return, a real-life wish of the child is actually granted via a fantasy character.

The fantasy character(s) can include an inanimate, physical doll such as a pixie and/or images of the character presented electronically on the visual screen of a communication/computing device. The child commits to adopt one or more fantasy characters as a member of the child's family and to work to ensure the happiness of the character(s). When a fantasy character emotes happiness, the child earns fantasy credits toward achieving a desired wish of the child granted by the fantasy character.

The individualized communication comprises the exchange of electronic messages with the child through the fantasy character by using a set of interactive communication/computing devices capable of exchanging personal communications over networks such as the global Internet and telecommunications systems. In reality, the child's parent or another trusted person controls the content of the communications appearing to come from the fantasy character including goal setting and the approving and granting of wishes communicated to the child through the fantasy character. Through the fantasy character and thus outside the role as a parent the parent provides the child with opportunities to experience and develop positive life skills through events and tasks selected by the parent which results in a happier child and in turn result in more positive behavior of the child in trusted, strengthened relationships. The proven, selected events and tasks include making a commitment to adopt the fantasy character into the family and being responsible to make the character happy, goal setting (identifying a desired wish to be achieved), servicing other persons and the fantasy character including tasks the child can perform to make the fantasy character happy, participating in regular positive self-affirmations thereby instilling self-worth in the child, participating in sing-a-long activities to promote children to feel powerful over how good/happy they feel and encourage them to treat others well and to encourage children to celebrate that they are good people and have many great qualities, and/or meditating or quiet thinking to allow the child to self-assess its own feelings and emotions and to identify mechanisms of self-control, self-regulation and coping, all of which result in allowing the child to achieve/earn its goal/wish through interaction with the fantasy character.

These and other features and advantages of the disclosed and claimed methods and system will be set forth or will become more fully apparent in the description that follows and in the appended claims. The features and advantages may be realized and obtained by employing the methods and system disclosed and claimed in this patent and as particularly pointed out in the appended claims and their equivalents. Furthermore, the features and advantages of the disclosed methods and system may be learned by the practice of it or will be obvious from the description, as set forth hereinafter.

### BRIEF DESCRIPTION OF THE DRAWINGS

In order that the manner in which the above referenced and other features and advantages of the disclosed methods and system are achieved, a more particular description will be rendered through reference to exemplary embodiments illustrated in the appended drawings. It will be appreciated that the following descriptions and drawings depict only exemplary embodiments of the disclosed methods and system and are not, therefore, to be considered as limiting in scope. Illustrative depictions include:

FIG. 1 is an exemplary illustration of a portion of the disclosed fantasy world including a fantasy character.

FIG. 2 is another exemplary illustration of a depiction of fantasy characters.

FIG. 3 is another exemplary illustration of a portion of the disclosed fantasy world including a fantasy character.

FIG. 4 is another exemplary illustration of a portion of the disclosed fantasy world including a fantasy character

### DETAILED DESCRIPTION OF THE INVENTION

The disclosed technology comprises methods and systems for teaching and encouraging children to be kind and caring, to grow emotionally stronger, and to be able to bring themselves back to a happy mindful state when they feel themselves unhappy. This includes methods and systems for parents to communicate to their child as a magical character in order to encourage particular behaviors and advise and encourage children outside of the role of parent. It is also a methods and systems for adopting and caring for a doll in addition to communicating with the doll for the purpose of showing the doll love, kindness, and empathy.

The disclosed, behavior-influencing methods and systems relate generally to the immersion of a person such as a child into a part fictional, part real experience or game in which another trusted person such as a parent interacts with the child through a chosen fictional or fantasy character. The parent uses the context of the fantasy character to identify certain events, tasks and activities in which the child then chooses to participate and through which the happiness of the fantasy character can be increased. As thanks for increased happiness, a fantasy character such as a pixie bestows a fantasy reward such as an amount of pixie dust upon the child. The amount of the fantasy rewards is accumulated until it reaches a predetermined level or amount needed for the fantasy character to grant a real wish which was previously chosen by the child and preapproved by the parent through the fantasy character. For example, a pixie's level of happiness may be displayed on a happiness bar on the game screen. A pixie may put a reward of pixie dust in a jar. When the pixie dust in the jar reaches an amount predetermined by the parent, that is the child has earned that amount of pixie dust, a predetermined wish of the child is granted by the pixie. The child is never punished for not making the pixie happy, the child's wishes are just delayed by a loss of pixie dust. In reality, the parent controls/is the fantasy character and controls some of the giving or removal of pixie dust.

The identified behaviors and activities fostered by the disclosed methods and system are designed to permit the child to experience successes and good feelings through goal setting, service to others, using positive self-affirmations and/or meditation and allow the child to achieve/earn a goal/wish chosen by the child by increasing the state of happiness of another.

A fantasy game of the disclosed methods and systems may comprise a combination of creating a story, providing an inanimate, physical object such as a fictitious character doll and using interactive electronic communication.

### The Story

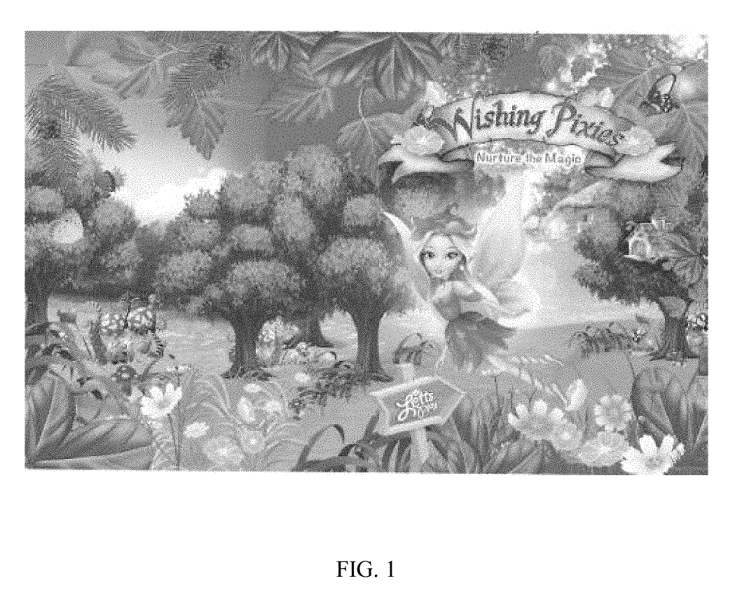

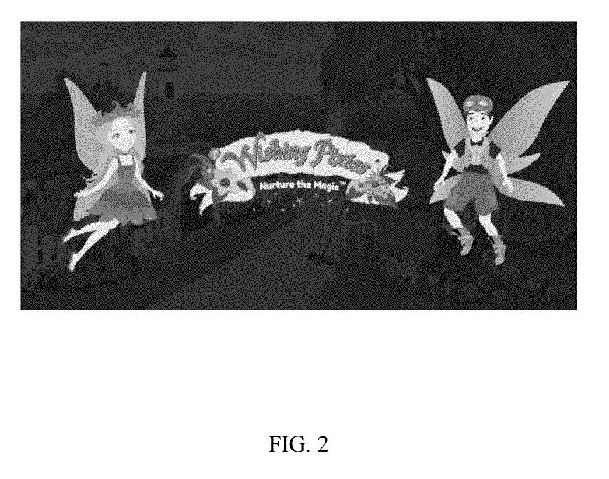

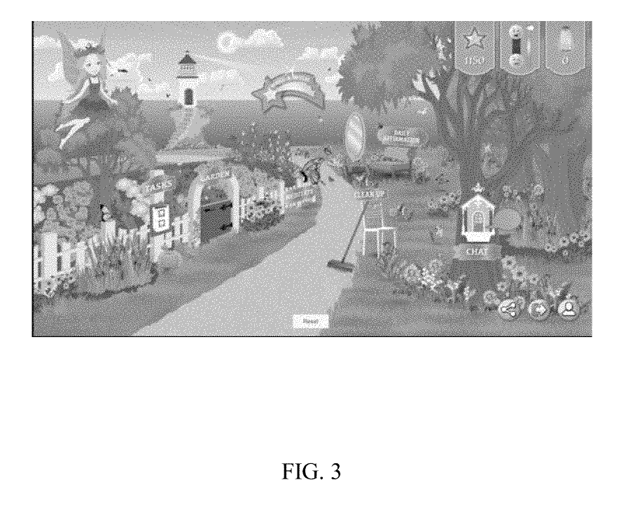

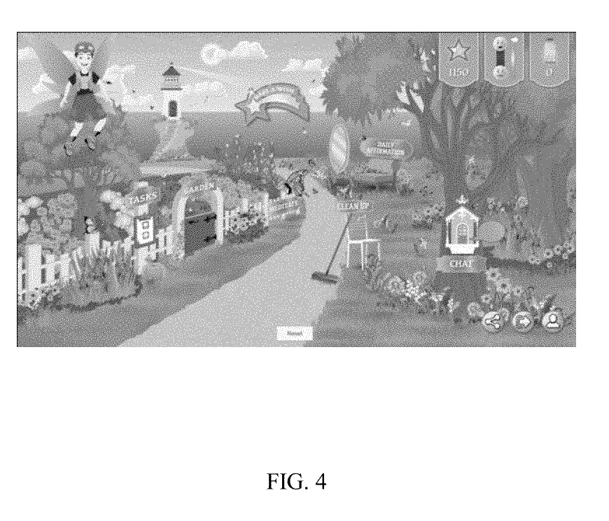

A fantasy game of the disclosed methods and systems may comprise the following steps: creating a fantasy world comprising one or more locations, creating one or more fantasy characters associated with the fantasy world, allowing the child to enter into a co-dependent relationship with at least one of the fantasy characters; identifying events and tasks, i.e., activities and behaviors, performed by the child which care for and/or increase the happiness of the selected fantasy character; allowing the child to request one or more wishes which the child would have the fantasy character grant; approving a requested wish dependent upon a predetermined amount of award accumulation which will allow the requested wish to be granted; causing the fantasy character to reward the child each time the child increases the happiness of the fantasy character; accumulating the fantasy rewards garnered by the child; granting an approved real-life wish of the child by and through the fantasy character when the accumulation of rewards reaches the parent-approved, predetermined amount. Exemplary depictions are shown in FIGS. 1-4.

A feature of the disclosed technology may comprise creating a story about fictional/fantasy world comprising one or more locations. The fictional world can be any unseen or imagined setting such as a fictional planet or orb comprising fantasy lands, bodies of water, lights, clouds, wind, weather, plants, animals, characters, modes of transportation, kingdoms, countries, villages, buildings, rooms, yards, gardens, weather, story lines, plots, competing interests, conflicts, intrigues, adventures, magic powers and any other fictional imaginations related to the fantasy existence. The context of the fictional world may create needs which the child can meet or problems which the child can help solve. An objective of the creation of the fantasy world is to attract the child's attention to an issue or issues of the fantasy world which evokes within the child a desire to engage in the interactive game to promote the welfare of a fantasy world and its characters, animals, etc.

A feature of the disclosed technology may comprise developing the nature and attributes of the fantasy characters, animals, plants, etc. needing assistance or help. For example, a fantasy character such as an innocent fairy or pixie with magical powers could need shelter, protection or other assistance in the face of some obstacle, challenge or evil-intending antagonist in the fantasy world or the real world. A fantasy animal or plant could need saving from some enemy, rival or environmental influence. A fantasy town, village, city, bridge, building, room, garden or other space could need help being built, preserved or maintained. Any nature of imaginary story of plat can be contrived to present fictional or actual characters, animals, plants, etc. whose welfare can be positively bettered by the child's interactive participation in the fantasy game and in real life. An objective of developing the nature and attributes of the fantasy characters is to create likeable friend and confidante for the child.

A feature of the disclosed technology may comprise allowing the child to enter into a co-dependent relationship with at least one of the fantasy characters, animals, plants, etc. (collectively “fantasy character”) in which the child agrees or commits to seek the increased happiness of the fantasy character. The establishment of this co-dependent relationship may be accomplished by some act of the child in the game by which the child communicates to the fantasy character some act of adoption, promise, obligation, oath, pledge, conduct or other action and/or any form of commitment which may lead to the increased happiness of the fantasy character. This could be done by allowing the child to send the fantasy character a letter, card, note, present, email or text message communicating the child's willingness to adopt, befriend and interact with the fantasy character. An objective of entering into a co-dependent relationship is to create a desired, mutual dependence and respect that provokes caring action.

A feature of the disclosed technology may comprise providing opportunities for the child to proactively care for the interests and requests of the fantasy character. Those interests are defined by the circumstances of the fantasy world and by the parent though the fantasy character. There can be needs and problems due to the circumstances in the fantasy world which the child can resolve. For example, the child can clean, beautify or otherwise maintain order in the fantasy character's homeland by picking up trash or pulled up flowers, gardening, cleaning off dirty items, standing upright items that are tipped over, straightening items that are disheveled, raking, picking up garbage, fixing broken trees, watering, sweeping up foot prints, mowing the lawn, putting birdhouses back up, etc. The child can also care for the inside of the home of the fantasy character by picking up clothes, making the bed, picking up toys, placing books on bookshelves, dusting, sweeping. The child can also serve the fantasy character directly by changing its clothes or performing other personal tasks. A certain number of attempts at these acts or completions can be allotted for each day. A certain amount of time can be allotted or counted down on a timer for completion of tasks. Caring for the needs and/or problems of the fantasy world by the child increases the happiness of the fantasy character.

Through the fantasy character, the parent can define events, tasks, behavior and other activities which the fantasy character requests or desires of the child as well as the criteria for the successful completion of each. For example, through good behavior of the child, participation in an event or activity or the successful completion of some task the child can satisfy the parent-initiated desires of the fantasy character on a daily, weekly or other recurring or non-recurring schedule. Parent-identified events, tasks and behavior may include any number of things such as keeping the child's room clean, sleeping in one's own bed, speaking respectfully, asking permission, saying thank you, doing homework without arguing, using proper table manners, putting clothes away, helping with household chores, taking care of pets, serving another, stating positive affirmation three times per day, taking time to think quietly or meditate several times per day, watching instructive videos, or any other wholesome or helpful events, tasks and behavior that the parent deems are expedient for the healthy development of the child. A certain number of attempts at these acts or completions can be allotted for each day. A certain amount of time can be allotted or counted down on a timer for completion of tasks. Obedience of the child to the parent-induced requests and desires of the fantasy character also increases the happiness of the fantasy character. An objective of having the child actively fulfill the perceived needs and desires of the fantasy character teaches the child that serving others increases the happiness and enjoyment of another bringing tranquility, harmony, connectedness and trust into the relationship.

A feature of the disclosed technology may comprise allowing the child to make a wish (set a goal) for some benefit or privilege and approving the requested wish through the fantasy character. To accomplish this the child communicates a wish to the fantasy character. The parent receives the requested wish and identifies the criteria for realizing the wish. The criteria may be the successful participation in the tasks, events, activities, etc. discussed above. When successfully completed, the fantasy character communicates the successful completion to the child and the game communicates to the child that the happiness of the fantasy character is increased, as discussed below. On the other hand, unsuccessful completion by child causes the fantasy character to be sad or emote disappointment.

For example, the game may include a reward system such that each time the happiness of the fantasy character is increased the child immediately receives an award token. For example, an award token could be an amount of pixie dust which the fantasy character, such as a pixie, deposits in a jar or some other container. The pixie dust accumulates in the jar so long as the child has successfully completed the criteria for obtaining the award token. Or, the award token can be some other collectable items such as stars or flowers or some other item the accumulation of which will lead to the granting of the child's wish. This allows the child to see immediate, measurable progress toward achieving the wish. An objective of giving the child incremental award tokens is to teach the child that goals are often achieved over the course of some time based on work or effort.

A feature of the disclosed technology may comprise a parental determination and approval of the amount or level of award accumulation garnered by the child hat is required before the fantasy character may grant the requested wish. For example, when the level of pixie dust reaches a predetermined amount in weight or height in a jar, which weight or level is established by the parent, the wish of the child is granted. Allowing the child to proactively chose to seek award tokens, the accumulation of which the child can monitor and see in the game display, incentivizes the child and allows the child to control the granting of its wish based upon the child's chosen conduct. An objective of this reward system teaches the child to set a goal, work to achieve the goal, monitor its progress in achieving the goal, obtain the desired benefit or privilege and recognize the satisfaction of being rewarded for ultimately achieving a goal.

A feature of the disclosed technology may comprise requiring the child to participate in certain activities known to increase character development. For example, positive affirmations given by another or positive self-affirmation given to oneself are proven to increase one's self-esteem and sense of self-worth. Positive self-affirmations can take many forms, including but not limited to, writing down a list of one's strengths, skills and gifts, speaking aloud positive statements about one's self, about others or about some issue facing the child, singing a song with positive messages, watching an affirming video, listening to positive affirmations given by others, reading positive affirmations, looking at oneself and reciting positive affirmations, positive sing-a-long events, etc. One or more activities required by the parent to obtain a wish/reach a goal can be participation in regular positive self-affirmation one or more times per day, preferably at least three times per day. Successful completion of a positive affirmation cycle may allow the child to earn award tokens. An objective of participating in regular, frequent positive affirmations is to instill self-worth and self-confidence in the child.

A feature of the disclosed technology may comprise meditating or quiet thinking to allow the child to self-assess its own feelings and emotions and to identify mechanisms of self-control, self-regulation and coping. Reliable scientific studies have repeatedly proven that a person's abilities to rationally think, analyze and reason dramatically decrease when the person is experiencing conditions such as pain, surprise, fright, stress, anxiety, fear or other triggers which cause irregular breathing, increased heart rate or abnormal blood pressure. These conditions can be caused by other persons, by environmental factors and/or by physiological, emotional, psychological and/or mental influences. A significant challenge for many people lies in the inability to think about how one is thinking when subject to these escalating kinds of conditions. Other reliable scientific studies have repeatedly proven that using periods of meditation or quiet thinking allows a person to deescalate otherwise detrimental or debilitating conditions permitting the person to more effectively think, analyze and reason so as to be able to self-monitor, self-assess and self-regulate.

Self-monitoring encompasses the ability of a person to recognize on their own when the person is under adverse conditions which impact the person's ability to think, analyze and reason. Self-assessment encompasses the ability of a person to recognize how, why and/or whether the person is able to effectively think, analyze and reason and the impact of adverse conditions. Self-regulation and coping encompasses the ability of a person to use previously identified techniques to remove, counteract or mitigate the otherwise recurring impairing effect of the detrimental or debilitating conditions thereby ensuring or restoring the person's ability to rationally think, analyze and reason. Often mediation and quiet thinking are combined with breathing techniques and/or video presentations which may enhance mediation and thinking. The meditation activities are preferably time-based and may vary in duration of time. It is preferred if meditation cycles are limited to more than three times per day. Successful completion of a mediation or quiet thinking cycle may allow the child to earn award tokens. An objective of meditation and/or quiet thinking is to help the child identify and recognize its own power and mechanism to control and use thinking, analyzing and reasoning skills with clarity when faced with otherwise adverse influences or challenging decisions, tasks, events or activities.

Development of the nature of the fantasy character may include many facets of gender, expression, physical size and appearance, shape, hair and skin color, clothing, ability to move about, body position such as standing, crouching, walking, jumping, floating or flying, magical or supernatural powers, facial expressions including ambivalent or normal, happy, sad or disappointed, moving lips and/or other non-verbal ways to communicate thoughts, feelings or emotions such as blinking and movement and position of the head, torso or limbs. While the variations in the development of the fantasy characters are nearly limitless, the objective of the character development is allow the fantasy character to effectively communicate to the child the fantasy character's, that is, the parent's level of happiness, sadness, disappointment and ambivalence to evoke a reaction in the child to impel it to positive action. See FIGS. 1-4.

### The Doll

The disclosed technology contemplates not only the electronic images and embodiments of the fantasy character discussed above, but also a physical, tangible doll figure to compliment the story. The physical doll helps to create the fantasy world and allows the child to have a tangible aspect of the relationship, a friend to take along, a sleeping buddy, a presence in a room. It is contemplated that the physical doll bear a neutral facial expression.

The doll is also instrumental in creating the relationships discussed above if the stories and care instructions outlined above are read from a hard-copy book independent of online content from a website or other source.

### The Interactive Electronic Communication

In the App parents can communicate back and forth with their child as the Pixie or fantasy character. Messages to the child can be selected from premade messages or create a personalized message. Children can send messages back through text or voice to text. Messages can be read through text to voice. Use of interactive electronic communications promotes a loving conversation between the child and parent/pixie.

One of skill in the art will know how to structure the images, content and interactive communications needed to create an online or mobile App to host these methods and systems including account registration, user roles, messaging and chatting, hosting positive affirmation activities, social medial integration, if any, hosting meditation cycles, notification reminders, image presentation, sounds, in game or online purchase options, core loop elements for making wishes, assisting in fantasy land, gardening, meditation, positive affirmations, tasks, granting wishes, giving reward tokens and all the associated animations.

An important feature of the interactive electronic telecommunications comprise the ability for the child and fantasy character/parent to communicate. This can be accomplished using telephones, iPad, messaging devices, computers, email, texting devices and the like.

Another important feature is the ability to present animated images to the child in association with the story and its associated communications, tasks, events, activities, behavior, etc. Such communication systems can be iOs or Android based, or any other platform configured to facilitate interactive communication.

The disclosed technology may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method for teaching a child loving, caring relationships comprising the steps of:
creating a fantasy world comprising one or more locations,
creating one or more fantasy characters associated with the fantasy world,
enter into a co-dependent relationship by the child with at least one of the fantasy characters selected by the child;
identifying events and tasks, i.e., activities and behaviors, performed by the child which care for and/or increase the happiness of the selected fantasy character;
request one or more wishes by the child which the child would have the fantasy character grant;
approving a requested wish dependent upon a parent-approved, predetermined amount of award accumulation which will allow the requested wish to be granted;
causing the fantasy character to reward the child each time the child increases the happiness of the fantasy character;
accumulating the fantasy rewards garnered by the child; and
granting an approved real-life wish of the child by and through the fantasy character when the accumulation of rewards reaches the parent-approved, predetermined amount.

2. The method of claim 1 further comprising providing a physical doll representing the fantasy character.

3. The method of claim 1 further comprising utilizing an interactive electronic telecommunications system to facilitate the communications between the child and the fantasy character/parent.

4. The method of claim 1 further comprising providing a book, scroll or electronic images to introduce the fantasy world and one or more fantasy characters.

5. The method of claim 1 further comprising providing cycles of positive affirmations or self-affirmations activities.

6. The method of claim 1 further comprising providing cycles of meditating or quiet thinking activities.

7. The method of claim 1 further comprising providing cycles of sing-a-long activities.

8. A computer game or mobile App for teaching a child loving, caring relationships, the game or App comprising:
a fantasy world comprising one or more locations,
one or more fantasy characters associated with the fantasy world,
a co-dependent relationship between the child and at least one of the fantasy characters selected by the child;
events and tasks, i.e., activities and behaviors, performed by the child which care for and/or increase the happiness of the selected fantasy character;
means for allowing the child to request one or more real-life wishes which the child would have the fantasy character grant;
means for approving a requested wish dependent upon a parent-approved, predetermined amount of award accumulation which will allow the requested wish to be granted;
recording rewards garnered by the child;
a display or image which shows the child its progress in reaching the parent-approved, predetermined amount of award accumulation;
means for allowing the fantasy character to communicate to the child that the requested real-life wish will be granted.

9. The computer game or mobile App of claim 8 further comprising a communication from the fantasy character to the child indicating that the requested wish will be granted.

10. The computer game or mobile App of claim 8 further comprising an interactive electronic telecommunications system to facilitate communications between the child and the fantasy character/parent.

11. The computer game or mobile App of claim 8 further comprising an electronic book or images to introduce the fantasy world and one or more fantasy characters.

12. The computer game or mobile App of claim 8 further comprising positive affirmation or self-affirmatios activities for the child.

13. The computer game or mobile App of claim 8 further comprising meditating or quiet thinking activities for the child.

14. The computer game or mobile App of claim 8 further comprising sing-a-long activities for the child.
